(19) United States
(12) Patent Application Publication
(10) Pub. No.: US 2013/0340337 A1
(43) Pub. Date: Dec. 26, 2013

(54) PLANT DEVELOP RACK

(71) Applicant: ELE-GARDEN LANDSCAPE CONSTRUCTION CO., Taichung City (TW)

(72) Inventors: Kong-Iong KUO, Taichung City (TW); Wei-Hsun Chang, Taichung City (TW)

(21) Appl. No.: 13/913,386

(22) Filed: Jun. 8, 2013

(30) Foreign Application Priority Data
Jun. 22, 2012 (TW) 101212083

(51) Int. Cl. A01G 9/02

(52) U.S. Cl. CPC A01G 9/023
USPC 47/82

(57) ABSTRACT

A plant develop rack includes a base, plural soil packages, a water supply device, and a water collecting tank. Plural rack units are disposed on the base and are arranged vertically. Each soil package encloses growth medium and plant and forms plural openings for the plant to extend outward. The water supply device is located above the rack units. Thereby, when the water supply provides water to the most upper rack unit, water may enter the soil package on that rack unit to nourish the plant. Thereafter, excess water may flow downward via draining holes of the rack unit to reach lower rack units. Thus, the soil packages on all rack units can acquire sufficient water for growing the plant.

### BACKGROUND OF THE INVENTION

1. Field of the Invention

The present invention relates to a plant develop rack.

2. Description of the Prior Art

A green wall having a plurality of plants is widely used for decorating, air-cooling, or air-filtering. However, watering the green wall becomes more difficult when the green wall is taller and wider. Especially when there is no sufficient space for standing, watering by human becomes quite difficult.

On the other hand, watering by human may result that the plants are watered unevenly. That is, some plants are watered too much to result rotting, and some other plants lack of water for growing. As a result, plants grow unevenly. Thus, the green wall has to be pruned frequently and need more maintenance.

### SUMMARY OF THE INVENTION

The main object of the present invention is to provide a plant develop rack which has no need to be watered by human.

To achieve the above and other objects, a plant develop rack of the present invention includes a base, a plurality of soil packages, a water supply device, and a water collecting tank.

The base is disposed with a plurality of rack units which are arranged spacedly along a vertical direction. Each rack unit is formed with a draining hole. Each soil package is disposed on one of the rack units and is adapted for enclosing growth medium and plant therein. Each soil package is formed with a plurality of openings for plant to extend outward. Each soil package is formed with a plurality of apertures so that water may penetrate the soil package. The water supply device is disposed on the base and is located above the rack units to provide water to the most upper soil package. By the draining holes, water can flow downward to one soil package to another package which is lower. The water collecting tank is disposed on the base and is located below the rack units.

Thereby, when the water supply device supplies water to the most upper rack unit, water can be absorbed by the soil package on that rack unit, and the excess water may flow downward to the lower rack unit via the draining hole. Thus, water may flow to each rack unit and enter each soil package so that the plant in the soil packages can be nourished. As a result, by the present invention, the plant doesn't have to be watered by human. On the contrary, the present invention promotes efficiency of watering so that the plant can be grown equally.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIGS. 2 and 3 are illustrations of the present invention.

### DETAILED DESCRIPTION OF THE PREFERRED EMBODIMENTS

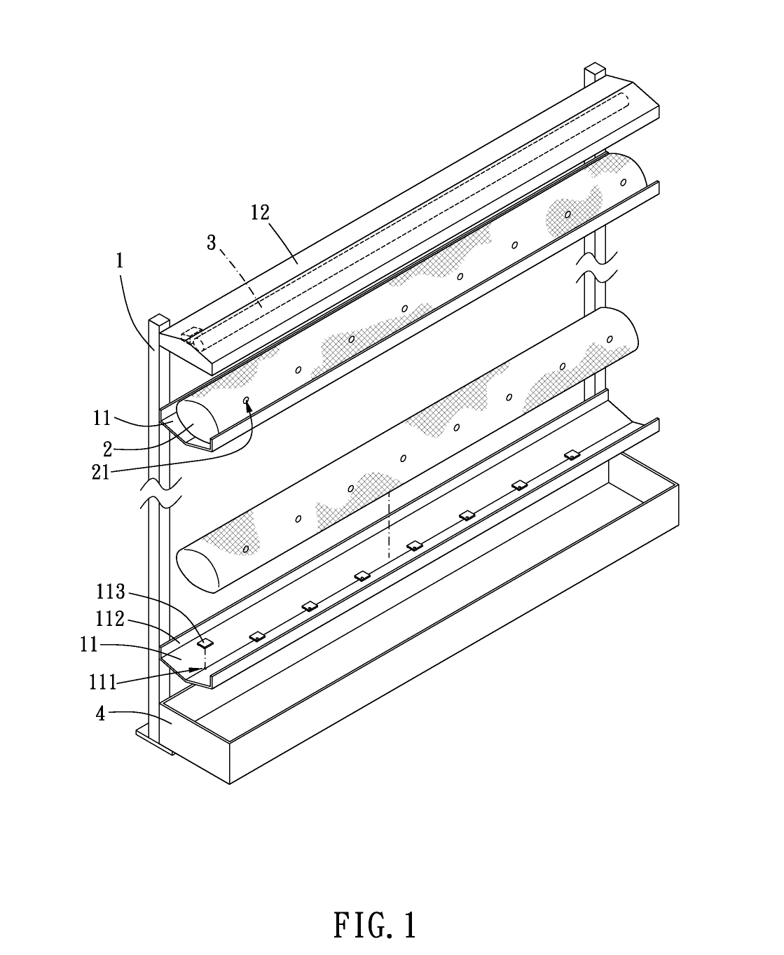

Please refer to FIG. 1, the plant develop rack of the present invention includes a base 1, a plurality of soil packages 2, a water supply device 3, and a water collecting tank 4.

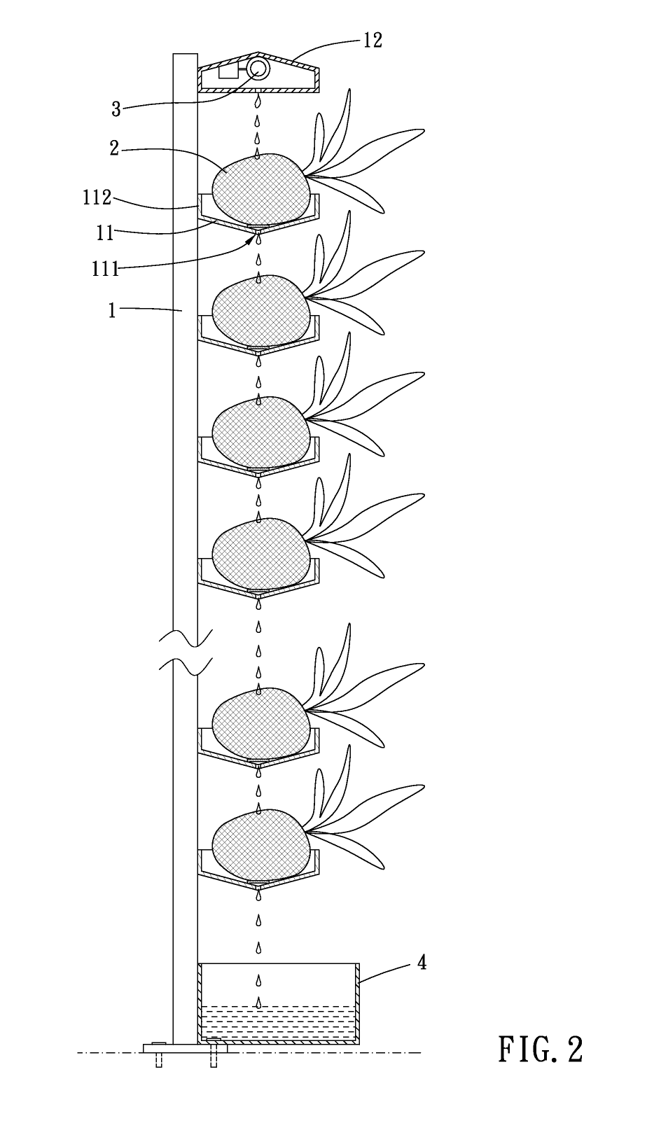

The base 1 is disposed with a plurality of rack units 11 wherein each rack unit 11 is formed with at least one draining hole 111. Preferably, each rack unit 11 has a center portion along its longitudinal direction wherein the center portion is recessed so that each rack unit 11 is substantially funnel-shaped, as shown in FIG. 2. A plurality of draining holes 111 are formed on a bottom of each rack unit 11. Besides, a cover plate 12 is disposed on the base 1 and is located above the rack units 11.

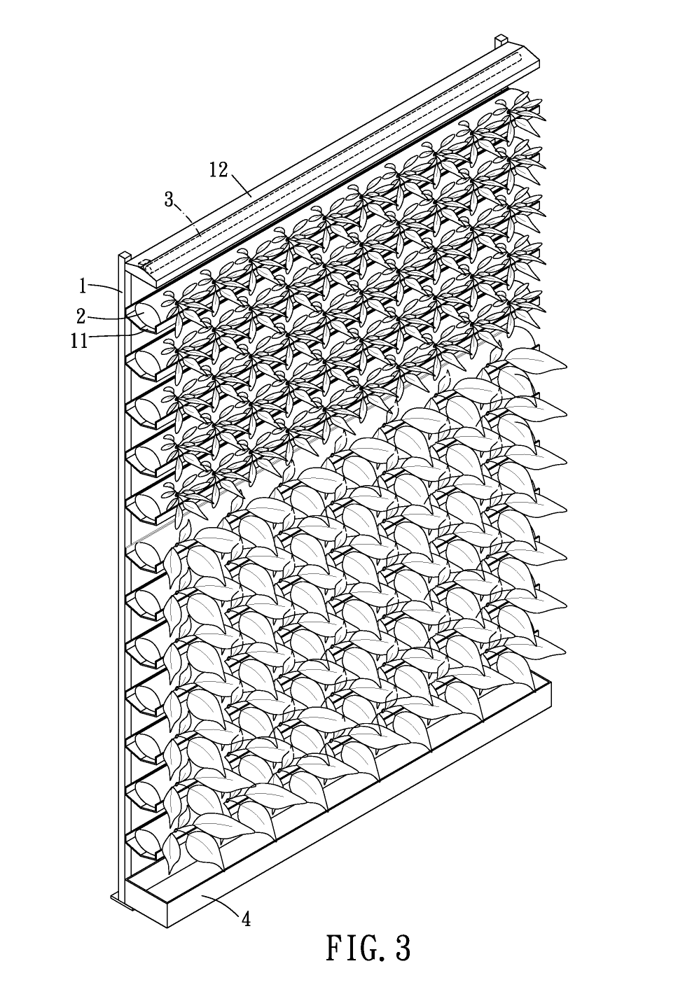

Each soil package 2 is disposed on one of the rack units 11 and is adapted for enclosing growth medium and plant. In the present embodiment, each soil package 2 encloses growth medium and plant by rolling. In addition, a blocking wall 112 is disposed at one of two sides of each rack unit 11 to prevent the soil package 2 from failing. Besides, each soil package 11 forms a plurality of openings 21 adapted for plant to extend outward so that the plant is able to grow along a specific direction. For example, in the present embodiment the openings 21 are formed on a side of each soil package 2 away from the base 1 and are located slightly higher than the blocking walls 112 so that the plant is able to grow backward the base 1 and further droops down, as shown in FIG. 3 On the other hand, each soil package 2 is formed with a plurality of apertures allowing fluid enter or leave the soil package 2. In the present embodiment, the soil package 2 is made of non-woven fabric.

The water supply device 3 is disposed on the base 1 and is located above the rack units. In the present embodiment, the water supply device 3 is located below the cover plate 12. The water supply device includes a water pipe and a plurality of sprinklers wherein the sprinklers are spacedly arranged along the longitudinal direction of the rack unit 11 in equal intervals. The water supply device is connected with a water source and supplies water via the sprinklers. Thereby, the water supply device 3 can provide fluid, such as water or culture solution, to the most upper soil package 2. Furthermore, via the draining holes 111, fluid is able to flow downward to reach the lower rack unit 11. Thereby, soil packages 2 on all rack units 11 may be provided with fluid. Besides, controller and fluid valve can be introduced into the present invention wherein the controller is adapted for alternating time of watering. In addition, fertilizing device can be also introduced.

The water collecting tank 4 is disposed on the base 1 and is located below the rack units 11 to collect fluid flowing out from the lowest rack unit 11. Fluid collected in the water collecting tank 4 can be introduced back to the water supply device 3 for re-using. Alternatively, fluid in the water collecting tank 4 can be adapted for fish-breeding or hydrophytes-culturing. Besides, the water collecting tank 4 is preferably bigger than each rack unit 11 to collect the fluid flowing down more easily.

In the preferred embodiment, a filter plate 113 is disposed on each rack unit 11 and is located above one of the draining holes 111. The filter plate 113 is formed with a plurality of tiny holes for filtering to prevent the draining holes 111 from jamming. Also, the filter plate 113 can be easily removed for cleaning.

Because the soil packages 2 are made of non-woven fabric, the soil packages 2 is advantageous in moisturizing and ventilation so as to promote growing of plant. Besides, each rack unit 11 is substantially funnel-shaped, so plant in the soil package 2 may not be immersed in fluid on the rack unit 11. Thus, infection or rotting may be avoided. In other possible embodiment, ventilators or fans can be introduced for promoting ventilation.

In use, as shown in FIG. 2 and FIG. 3, the water supply device 3 waters the most upper rack unit 11 to moisturize the soil package 2 on that rack unit 11. Excess water may further flow downward via the draining holes 111 to reach the lower rack unit 11. Thereby, water can be passed through all the rack units 11 to water plant in all the soil packages 2. Thereafter, excess water may flow into the water collecting tank 4 which is located the lowest. Thus, water-wasting can be prevented, and efficiency of watering can be increased. Also, water may not splash outside.

On the other hand, the soil packages 2 facilitate water spreading therein and capillarity. Thus, the plant inside the soil packages 2 can be nourished better and equally. As a result, the plant doesn't have to be pruned frequently.

Furthermore, the soil packages 2 enclose growth medium and plant by rolling so that the root of the plant acquires larger space for stretching. Also, the present invention can be utilized to grow various kinds of plant, as shown in FIG. 3. Besides, the elongated soil packages 2 facilitate adjustment of directions of the openings 21 by users.

In the present embodiment, all the rack units 11 are disposed on the same side of the base 1. However, in other possible embodiments, the rack units can be disposed inside the base, and the soil packages are formed with openings toward two sides of the base. Thus, plant is able to grow toward two sides of the base. Of course, the rack units can be disposed at two sides of base.

What is claimed is:

1. A plant develop rack, including:
a base, disposed with plural rack units arranged along a vertical direction, each rack unit being formed with at least one draining hole;
a plurality of soil packages, each soil package being disposed on one of the rack units, each soil package being adapted for enclosing growth medium and plant therein, each soil package being formed with a plurality of openings adapted for the plant to extend outward, each soil package being further formed with a plurality of apertures adapted for fluid to penetrate the soil package;
a water supply device, disposed on the base and located above the rack units to supply fluid to the most upper one of the soil package, fluid being able to drop to lower soil package due to the draining hole of each rack unit;
a water collecting tank, disposed on the base and located below the rack units.

2. The plant develop rack of claim 1, wherein each soil package encloses growth medium and plant in a manner of rolling.

3. The plant develop rack of claim 1, wherein a center portion is recessed to be funnel-shaped, a plurality of draining holes are formed on a bottom of each rack unit.

4. The plant develop rack of claim 2, wherein a center portion is recessed to be funnel-shaped, a plurality of draining holes are formed on a bottom of each rack unit.

5. The plant develop rack of claim 1, wherein the soil package is made of non-woven fabric.

6. The plant develop rack of claim 1, wherein each opening of each soil package is located at a side of the soil package away from base.

7. The plant develop rack of claim 1, wherein a filter plate is disposed on each rack unit and is located above each draining hole.

8. The plant develop rack of claim 2, wherein a filter plate is disposed on each rack unit and is located above each draining hole.

9. The plant develop rack of claim 3, wherein a filter plate is disposed on each rack unit and is located above each draining hole.

10. The plant develop rack of claim 4, wherein a filter plate is disposed on each rack unit and is located above each draining hole.

11. The plant develop rack of claim 5, wherein a filter plate is disposed on each rack unit and is located above each draining hole.

12. The plant develop rack of claim 6, wherein a filter plate is disposed on each rack unit and is located above each draining hole.
